(19) United States
(12) Patent Application Publication
(10) Pub. No.: US 2026/0245353 A1
(43) Pub. Date: Aug. 20, 2026

(54) LIGHTWEIGHT UNDERWATER OBJECT DETECTION METHOD

(71) Applicant: GUANGDONG OCEAN UNIVERSITY, Zhanjiang (CN)

(72) Inventors: Mingxin LIU, Zhanjiang (CN); Yujie WU, Zhanjiang (CN); Jing CHEN, Zhanjiang (CN); Ruixin LI, Zhanjiang (CN)

(73) Assignee: GUANGDONG OCEAN UNIVERSITY, Zhanjiang (CN)

(21) Appl. No.: 19/641,476

(22) Filed: Apr. 7, 2026

Related U.S. Application Data
(63) Continuation of application No. PCT/CN2025/132791, filed on Nov. 5, 2025.

(30) Foreign Application Priority Data
Nov. 6, 2024 (CN) 202411574023.3

(51) Int. Cl. G06V 10/82; G06N 3/045; G06N 3/048; G06N 3/082; G06V 20/05

(52) U.S. Cl. CPC G06V 10/82; G06N 3/045; G06N 3/048; G06N 3/082; G06V 20/05

(57) ABSTRACT

Disclosed is a lightweight underwater object detection method. The method includes: using YOLOv8 as a baseline model, implementing feature reuse in a network backbone of the YOLOv8 using a lightweight RepGhost re-parameterization module, and replacing a convolution layer of the network backbone with an SPD convolution module; replacing a network neck of the YOLOv8 with a global feature pyramid network (GFPN) for feature fusion; replacing a network head of the YOLOv8 with a CLLA detection head to improve recognition and positioning of an object, thereby obtaining a lightweight underwater object detection model; performing performance evaluation on the lightweight underwater object detection model, and applying the lightweight underwater object detection model to a real-world scenario to realize underwater object detection.

### CROSS-REFERENCE TO RELATED APPLICATIONS

This application is a continuation of International Patent Application No. PCT/CN2025/132791, filed on Nov. 5, 2025, which claims priority to Chinese Patent Application No. 202411574023.3, filed on Nov. 6, 2024, the entire contents of each of which are hereby incorporated by reference.

### TECHNICAL FIELD

The present disclosure relates to the field of underwater object detection technology, and in particular to a lightweight underwater object detection method.

### BACKGROUND

Underwater object detection plays a crucial role in fishery resource assessment and ecological environment protection. With the growing global focus on sustainable development, it has become particularly important to accurately monitor the status of underwater ecosystems and resources. In recent years, deep learning-based object detection technologies have been widely applied in various fields. Deep learning-based object detection algorithms are mainly divided into two-stage object detection algorithms and one-stage object detection algorithms. The former works on the principle of first generating candidate regions and then performing classification and localization on these candidate regions, and it features high detection accuracy but has a complex structure and poor real-time performance. The latter directly completes object detection in a single forward propagation process without the need to generate candidate regions.

However, traditional underwater object detection methods often face challenges in complex underwater environments, such as insufficient lighting, clutter interference, and limited computational resources, resulting in inadequate detection accuracy and failure to fully consider model lightweighting to meet practical deployment requirements, which in turn restricts effective resource management and ecological monitoring.

Therefore, the development of efficient and reliable underwater object detection technologies not only helps to improve the accuracy of fishery resource assessment but also provides a scientific basis for ecological environment protection, so as to ensure the sustainable development of marine ecosystems.

### SUMMARY

In view of the aforementioned deficiencies, a lightweight underwater object detection method provided in the present disclosure addresses the problems that in traditional manners, it is difficult to achieve accurate detection in complex underwater environments and with limited computing resources, and fails to take model lightweighting into account.

To achieve the above objective, a technical solution adopted in the present disclosure is: a lightweight underwater object detection method, including:
S1: using YOLOv8 as a baseline model, implementing feature reuse in a network backbone of the YOLOv8 using a lightweight RepGhost re-parameterization module, and replacing a convolution layer of the network backbone with an SPD convolution module;
S2: replacing a network neck of the YOLOv8 with a global feature pyramid network (GFPN) for feature fusion;
S3: replacing a network head of the YOLOv8 with a CLLA detection head to improve recognition and positioning of an object, thereby obtaining a lightweight underwater object detection model;
S4: performing performance evaluation on the lightweight underwater object detection model, and applying the lightweight underwater object detection model to a real-world scenario to realize underwater object detection.

In some embodiments, the RepGhost re-parameterization module in S1 utilizes re-parameterization technology to sequentially add a batch normalization layer, an Add connection layer, and an activation layer after a deformable convolution layer, and add a batch normalization branch between the deformable convolution layer and the Add connection layer.

In some embodiments, the SPD convolution module in S1 performs operations including:
S11: downsampling an original feature map X(S×S×C₁) having a size of S×S×C₁ using a scaling factor to obtain feature sub-maps, wherein S denotes a spatial dimension of the original feature map, and C₁ denotes a count of channels of the original feature map;
S12: connecting the feature sub-maps along a channel dimension to obtain a feature map X′(S Scale, S Scale, Scale²C₁), wherein Scale denotes a scaling coefficient; and
S13: converting the feature map X′(S Scale, S Scale, Scale²C₁) into

$${X}^{″} ( \frac{S}{Scale} , \frac{S}{Scale} , {Scale}^{2} {C}_{2} )$$

by adding a convolution layer with C₂ filters.

In some embodiments, a formula for obtaining the feature sub-maps in S11 is:

$$\begin{matrix}{f}_{x , y} = X [ x : S : Scale , y : S : Scale ] ; \\ x = 0 , 1 , … , Scale - 1 , y = 0 , 1 , … , Scale - 1 ;\end{matrix}$$

where f_{x,y} denotes the feature sub-map, X[⋅] represents an input feature map or tensor, and x and y denote coordinate subscript indices.

In some embodiments, the GFPN in S2 utilizes CSPStage to implement a skip connection, and simultaneously replaces C2f with the CSPStage and combines the convolution layer.

In some embodiments, the CLLA detection head in S3 includes a CLLA cross-layer local attention mechanism layer and a DFL loss function layer, and the CLLA cross-layer local attention mechanism layer and the DFL loss function layer are connected via the convolution layer.

In some embodiments, the CLLA cross-layer local attention mechanism layer performs operations including:
S31: assuming that a low-level feature map

$${F}_{1}^{′}$$

and a mid-level feature map

$${F}_{2}^{′}$$

contain shallow information, and a high-level feature map

$${F}_{3}^{′}$$

contains deep semantic information;
S32: respectively reducing a spatial size of the low-level feature map

$${F}_{1}^{′}$$

and a spatial size of the mid-level feature map

$${F}_{2}^{′}$$

by using average pooling and 1×1 convolution, and unifying a count of channels, to obtain a new low-level feature map

$${F}_{1}^{l}$$

and a new mid-level feature map

$${F}_{2}^{m} ,$$

such that the spatial size of the new low-level feature map

$${F}_{1}^{l}$$

and the spatial size of the new mid-level feature map

$${F}_{2}^{m}$$

are the same as the spatial size of the high-level feature map

$${F}_{3}^{′} ;$$

S33: using learnable parameters to project the new low-level feature map

$${F}_{1}^{1}$$

into a space of Q, and to project the new mid-level feature map

$${F}_{2}^{m}$$

into spaces of K and V respectively, with formulas as follows:

$$\begin{matrix}Q = {F}_{1}^{l} {W}^{Q} ; \\ K = {F}_{2}^{m} {W}^{K} ; \\ V = {F}_{2}^{m} {W}^{v} ;\end{matrix}$$

where Q, K, and V represent a query vector, a key vector, and a value vector respectively, and W^{Q}, W^{K}, and W^{V} denote three learnable parameters used to generate the query vector, the key vector, and the value vector respectively;
S34: calculating a correlation weight between the Q and the K by using a dot product and a softmax function, and then performing a dot product between the correlation weight and the V to obtain a new feature map;
S35: adding the new feature map to the high-level feature map

$${F}_{3}^{′}$$

to obtain an aggregated feature map F_{M}, with a formula as follows:

$${F}_{M} = {F}_{3}^{′} + softmax ( \frac{( {F}_{1}^{l} {W}^{Q} ) {( {F}_{2}^{m} {W}^{K} )}^{T}}{\sqrt{{d}_{k}}} ) ( {F}_{2}^{m} {W}^{V} ) ,$$

where softmax(⋅) denotes an activation function, T denotes a matrix transpose, and dₖ denotes a vector dimension used for calculating an attention weight.

In some embodiments, the DFL loss function layer uses a cross-entropy function to focus a network distribution near a label value, with a formula as follows:

$${DFL}_{( {S}_{i} {S}_{i + 1} )} = - ( ( {P}_{i + 1} - P ) log ( {S}_{i} ) + ( P - {P}_{i} \cdot ) log ( {S}_{i + 1} ) ) ;$$

where DFL₍ₛ_{ᵢ}_{,s}_{ᵢ₊₁}₎ denotes a distributed focus loss of a predicted value at two adjacent positions i and i+1, Sᵢ denotes an output of a network Sigmoid at the position i, Sᵢ₊₁ denotes an output of the network Sigmoid at the position i+1, Pᵢ denotes a probability of a label P at the position i, and Pᵢ₊₁ denotes a probability of the label P at the position i+1.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, wherein:

FIG. 1 is a flowchart illustrating an exemplary process for lightweight underwater object detection according to some embodiments of the present disclosure;

FIG. 2 is a diagram illustrating a network structure of an underwater object detection model, i.e., LFN-YOLO, according to some embodiments of the present disclosure;

FIG. 3 is a schematic diagram illustrating a re-parameterization process of a RepGhost re-parameterization module according to some embodiments of the present disclosure;

FIG. 4 is a diagram illustrating a feature map transformed by Space-to-depth when Scale=2 according to some embodiments of the present disclosure.

FIG. 5 is a diagram illustrating a feature fusion structure of a global feature pyramid network (GFPN) according to some embodiments of the present disclosure; and

FIG. 6 is a diagram illustrating a structure of a CLLA cross-layer local attention mechanism layer according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with the accompanying drawings without creative labor. The present disclosure may be applied to other similar scenarios based on these drawings without creative labor. Unless obviously obtained from the context or the context illustrates otherwise, the same numeral in the drawings refers to the same structure or operation.

It should be understood that, as used herein, the terms “system”, “device”, “unit”, and/or “module” as used herein are used to distinguish between different components, elements, parts, sections, or assemblies at different levels. However, the words may be replaced by other expressions if other words accomplish the same purpose.

As shown in the present disclosure and the claims, unless the context clearly suggests an exception, the words “one,” “a”, “an”, and/or “the” do not refer specifically to the singular, but may also include the plural. In general, the terms “include” and “comprise” only suggest the inclusion of explicitly identified operations and elements that do not constitute an exclusive list, and the method or device may also contain other elements.

The present disclosure uses flowcharts to illustrate operations performed by a system according to embodiments of the present disclosure. It should be understood that preceding or following operations are not necessarily performed precisely in sequence. Instead, the operations may be processed in reverse order or simultaneously. Meanwhile, other operations may be added to these processes, or one or more operations may be removed from these processes.

The present disclosure is further described below with reference to the accompanying drawings and specific embodiments.

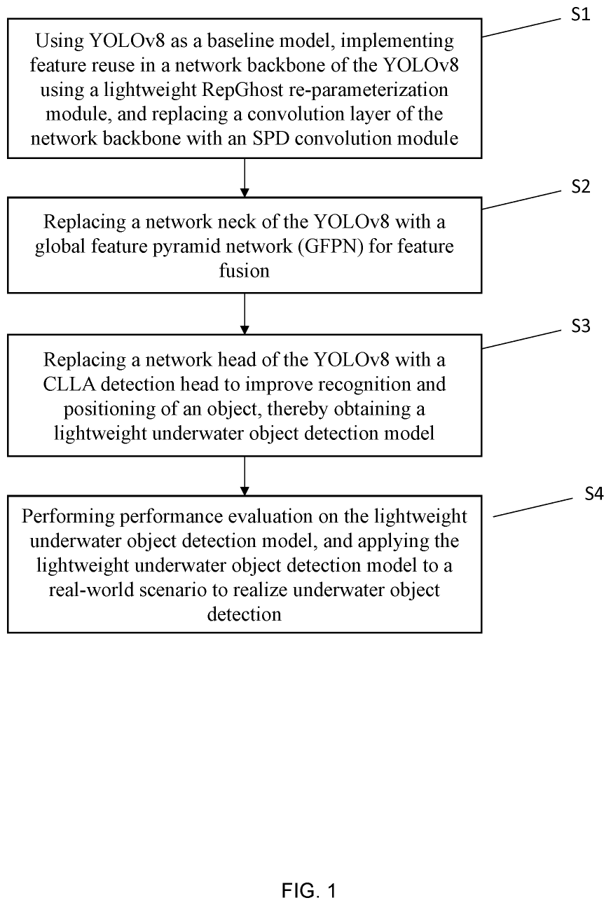

FIG. 1 is a flowchart illustrating an exemplary process for lightweight underwater object detection according to some embodiments of the present disclosure. The lightweight underwater object detection method may be executed by a processor. The processor may be a central processing unit, a microprocessor, etc.

As shown in FIG. 1, a lightweight underwater object detection method includes the following operations S1-S4.

In S1, taking YOLOv8 as a baseline model, a lightweight RepGhost re-parameterization module is adopted for a network backbone of the YOLOv8 to achieve feature reuse, and an SPD convolution module is used to replace a convolution layer of the network backbone.

The baseline model refers to an initial model used to obtain a final lightweight underwater object detection model.

The lightweight underwater object detection model refers to a machine learning model that can detect underwater objects in real-time and with high accuracy on resource-constrained devices (e.g., an underwater robot, an edge device, etc.). The lightweight underwater object detection model is hereinafter referred to as the “object detection model.”

YOLOv8 may be a real-time object detection model. YOLOv8 may be a real-time object detection model released by Ultralytics.

In some embodiments, a network structure of the YOLOv8 may include a network backbone, a network neck, and a network head.

The network backbone may be configured to extract multi-scale feature maps from an input image and output the multi-scale feature maps to the network neck in operation S2 below. The input image may be an image reflecting an underwater ecological environment. The input image may be captured by an image sensor. The multi-scale feature maps refer to feature maps extracted by the network backbone from the input image, which have different spatial resolutions (e.g., sizes, etc.) and different semantic levels. For example, the multi-scale feature maps include a high-resolution feature map and a low-resolution feature map. The high-resolution feature map retains rich low-level spatial information (e.g., edge, texture, etc.) and is suitable for detecting a small object. The small object refers to an object or region in an image that occupies a pixel area equal to or less than 1% of a total area of the image. The low-resolution feature map contains high-level semantic information (e.g., the overall shape of an object, etc.) and is suitable for detecting a large object. The large object refers to an object or region in an image that occupies a pixel area exceeding 10% of a total area of the image.

The convolution layer of the network backbone refers to a convolution layer responsible for progressively extracting multi-scale semantic information (e.g., edge, texture, object shape, etc.) of the input image.

The RepGhost re-parameterization module is a re-parameterization module for lightweight convolutional neural networks (CNNs). The RepGhost re-parameterization module may be an existing module on the market.

The feature reuse refers to a design strategy in a neural network that enhances the expression efficiency of the finally obtained object detection model, reduces computational redundancy, or improves gradient flow by sharing or reusing feature maps of the same level (or different levels).

The SPD convolution module includes a space-to-depth layer and a non-strided convolution layer. The space-to-depth layer is configured to perform downsampling on an original feature map while preserving information in the channel dimension to avoid the loss of information of intermediate feature maps in terms of size. The non-strided convolution layer is configured to perform feature extraction without reducing the resolution. For more descriptions of the SPD convolution module, please refer to the relevant descriptions below.

In S2, a global feature pyramid network (GFPN) is used to replace the network neck of the YOLOv8 for feature fusion.

The network neck is configured to receive the multi-scale feature maps output by the network backbone, perform fusion of the multi-scale feature maps, and then output enhanced multi-scale feature maps. The network neck can enhance the robustness of the object detection model.

The global feature pyramid network (GFPN) is a multi-scale feature fusion architecture for underwater object detection or semantic segmentation.

In some embodiments, the global feature pyramid network (GFPN) is configured to receive the multi-scale feature maps output by the network backbone, perform fusion of the multi-scale feature maps, and then output enhanced multi-scale feature maps.

In S3, a CLLA detection head is used to replace the network head of the YOLOv8 to improve the recognition and positioning of an object, thereby obtaining a lightweight underwater object detection model.

The network head is configured to predict a category and a position of an underwater object based on the enhanced multi-scale feature maps output by the network neck. The underwater object refers to an underwater target or organism that needs to be detected, identified, or monitored. For example, the underwater objects include various fish, coral reefs, marine debris, etc.

The CLLA detection head refers to a detection head that can optimize the localization and classification performance of multi-scale underwater objects through cross-layer feature linking and an attention mechanism.

In some embodiments, a processor may execute operations S1-S3 as described above to obtain the lightweight underwater object detection model.

In S4, the performance evaluation is performed on the lightweight underwater object detection model, and the lightweight underwater object detection model is applied to a real-world scenario to realize underwater object detection.

The performance evaluation may include an evaluation precision (P), a recall (R), an average precision (mAP), a computational complexity (FLOPs), a count of parameters (Parameters), frames per second (FPS) of the object detection model, etc.

For more descriptions of the specific implementation details of the performance evaluation, please refer to the relevant descriptions in Table 1 and Table 2 below.

The real-world scenario refers to an actual environment where the object detection model is located. For example, the real-world scenario may include a real underwater environment where the object detection model is located.

In some embodiments, the object detection model may be installed on an underwater drone platform. The underwater drone platform may then be placed in a real-world scenario. The processor may control the object detection model to implement the underwater object detection. The underwater drone platform refers to an intelligent device that can autonomously navigate and perform tasks underwater through remote control or automatic control. Merely by way of example, the underwater drone platform includes an underwater robot, a diving robot, etc.

The present disclosure proposes a lightweight underwater object detection method for underwater object recognition, which can ensure detection performance for normal-sized objects while improving detection performance for small-sized objects, and reduce the count of parameters and computational complexity of the object detection model.

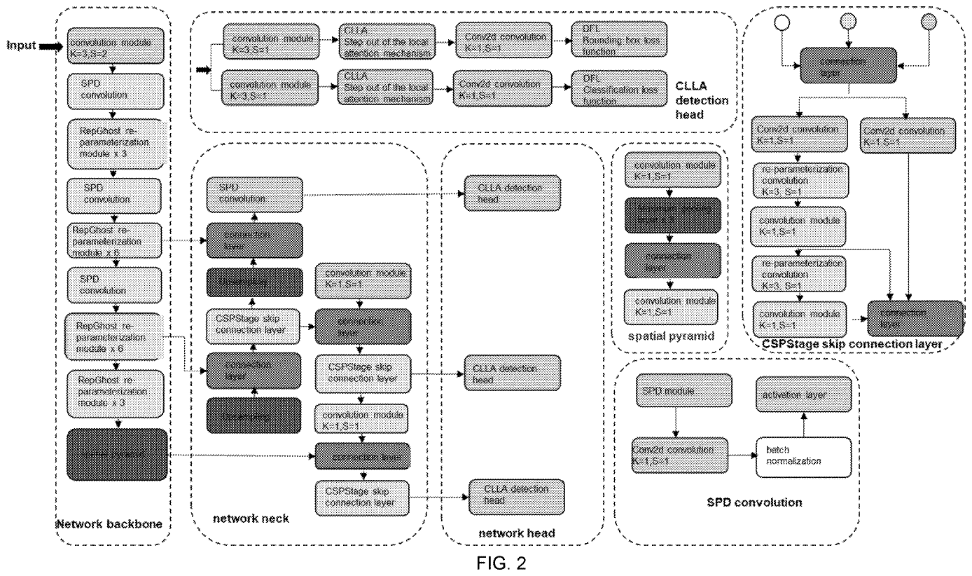

FIG. 2 is a diagram illustrating a network structure of an underwater object detection model, i.e., LFN-YOLO, according to some embodiments of the present disclosure.

As shown in FIG. 2, firstly, the present disclosure proposes using a RepGhost re-parameterization module to improve a network backbone of YOLOv8 to achieve feature reuse. Secondly, an SPD convolution module is used to replace the strided convolution in the network backbone of YOLOv8, and a pooling layer is added to the network backbone. Then, a feature fusion method of the network neck of YOLOv8 is improved to a global feature pyramid network (GFPN). This allows for sufficient information exchange between high-level semantic information and low-level spatial information. Finally, a CLLA detection head combining a cross-layer attention mechanism and a distributed focus loss is proposed to replace the original detection head of YOLOv8, so as to improve the object recognition and localization of the object detection model. Ultimately, the LFN-YOLO underwater object detection model is formed.

The underwater object detection model LFN-YOLO proposed in the present disclosure can better balance the accuracy and model complexity, and adapt to object detection of an underwater drone platform with limited hardware performance. Compared with mainstream vision models, the underwater object detection model LFN-YOLO boasts superior accuracy and a more compact size, and is capable of achieving accurate underwater object detection with limited computing resources.

In some embodiments, the RepGhost re-parameterization module in S1 utilizes re-parameterization technology to sequentially add a batch normalization layer, an Add connection layer, and an activation layer after a deformable convolution layer, and add a batch normalization branch between the deformable convolution layer and the Add connection layer.

The re-parameterization technology refers to a method used in deep learning to change the structure or the parameter representation of an object detection model through an equivalent transformation.

The deformable convolution layer allows sampling point positions of a convolution kernel to adaptively shift based on an input image. An object detection model with the deformable convolution layer can better capture features of underwater objects with irregular shapes. Features of the underwater object may include a shape, a material, a motion state, etc., of the underwater object.

The batch normalization layer can perform standardization processing on input data. The standardization processing may include causing the mean of the input data to be 0, the variance to be 1, etc.

The Add connection layer can directly add input data to output data through identity mapping to solve a gradient vanishing problem in deep networks.

The activation layer can enable a neural network of a finally obtained object detection model to fit complex functions, breaking through the limitations of linear models. The activation layer may also be referred to as a ReLU activation layer.

The batch normalization branch refers to an independent path or a sub-network in a neural network structure specifically designed to handle batch normalization (BN) operations. The batch normalization branch can enhance the expression capability or stability of the finally obtained object detection model through different normalization strategies.

Feature reuse plays an important role in lightweight convolutional neural networks. Existing feature reuse manner typically utilizes concatenation operations to reuse feature maps from other layers to maintain a large count of channels. But the manner has a high computational cost on hardware devices, which brings some trouble to practical industrial applications. Therefore, the present solution proposes to add the RepGhost re-parameterization module to the network backbone of YOLOv8 to realize feature reuse by structural re-parameterization technology, and to abandon the computational burden caused by the serial operators commonly used in previous feature reuse.

For the RepGhost re-parameterization module, a concatenation operator in Ghost is replaced with an Add operator, which features shorter time consumption and higher efficiency. Subsequently, a ReLU activation layer is moved to a position after a depthwise convolution layer and an addition operation layer to comply with the rules of a re-parameterization structure. Finally, a batch normalization (BN) branch is added to the RepGhost re-parameterization module, and the depthwise convolution layer is fused during an inference process, thereby reducing floating-point operations.

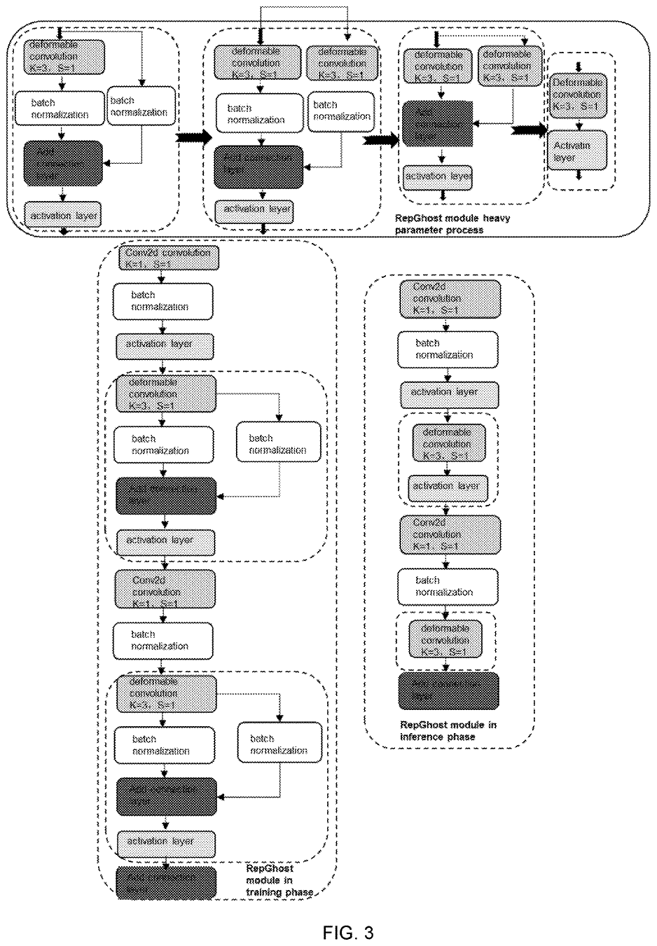

FIG. 3 is a schematic diagram illustrating a re-parameterization process of a RepGhost re-parameterization module according to some embodiments of the present disclosure. The RepGhost re-parameterization module may also be referred to as a RepGhost module.

Introducing the RepGhost re-parameterization module into the network backbone of YOLOv8 allows for more efficient training of the object detection model. During an inference phase, the detection speed of the object detection model is effectively improved while the loss of accuracy is reduced, which balances simplified model complexity and efficient detection performance of the object detection model, and can meet requirements for performing object detection tasks under conditions of limited hardware performance in industrial applications.

In object detection, when a target is small, feature information is limited. In this case, the use of normal step convolution and pooling may lead to the loss of granularity information, which is the key factor leading to the low efficiency of small-sized object detection. The small target may be understood as an object or region that occupies a pixel area in an image equal to or less than 1% of a total area of the image. To solve this problem, according to some embodiments of the present disclosure, a convolution method named the SPD convolution module is introduced to replace a convolution layer in the YOLOv8 network.

In some embodiments, the SPD convolution module in S1 performs the following operations S11-S13.

In S11, a downsampling process is performed on an original feature map X(S×S×C₁) having a size of S×S×C₁ using a scaling factor to obtain feature sub-maps, wherein S denotes a spatial dimension of the original feature map, and C₁ denotes a count of channels of the original feature map.

The original feature map refers to a feature map input to the SPD convolution module in the neural network.

The scaling factor is used to determine a reduction multiple of the original feature map. The scaling factor may be preset by a person skilled in the art based on experience.

The feature sub-map refers to a feature map obtained by reducing the original feature map according to the scaling factor.

The spatial dimension of the original feature map refers to a height and a width of the original feature map, i.e., a two-dimensional size of the original feature map in space.

The count of channels of the original feature map refers to a count of channels that transmit information in parallel in the original feature map. The count of channels of the original feature map may be preset by a person skilled in the art based on experience.

In some embodiments, a formula for obtaining the feature sub-maps in S11 is:

$$\begin{matrix}{f}_{x , y} = X [ x : S : Scale , y : S : Scale ] ; \\ x = 0 , 1 , … , Scale - 1 , y = 0 , … , Scale - 1 ;\end{matrix}$$

where f_{x,y} denotes the feature sub-map, X[⋅] represents an input feature map or tensor, Scale denotes a scaling coefficient, and x and y denote coordinate subscript indices, which are used to divide the feature sub-map. Values of x and y are positive integers greater than 0. The feature map may be an output of a layer in the SPD convolution module. The tensor may be a multi-dimensional array. The tensor may be used to store the feature map.

The scaling coefficient may be used to adjust a spatial dimension (resolution) of the feature map or a numerical range. In some embodiments, the scaling coefficient may be preset by a person skilled in the art based on actual needs.

In S12, the feature sub-maps are connected along a channel dimension to obtain a feature map X′(S Scale, S Scale, Scale²C₁), wherein Scale denotes a scaling coefficient.

In S13, the feature map X′(S Scale, S Scale, Scale²C₁) is converted into

$${X}^{″} ( \frac{S}{Scale} , \frac{S}{Scale} , {Scale}^{2} {C}_{2} )$$

by adding a convolution layer with C₂ filters.

The convolution layer with C₂ filters refers to a convolution layer that uses C₂ independent convolution kernels for feature extraction. The value of C₂ may be preset by a person skilled in the art based on experience.

In some embodiments, the processor may input the feature map X′(S Scale, S Scale, Scale²C₁) into the convolution layer with C₂ filters. The convolution layer with C₂ filters outputs

$${X}^{″} ( \frac{S}{Scale} , \frac{S}{Scale} , {Scale}^{2} {C}_{2} )$$

after conversion.

Each feature sub-map is obtained by down-sampling the original feature map X with a scaling factor. Subsequently, these feature sub-maps are concatenated along the channel dimension to obtain a feature map X′. A spatial size and a count of dimensions of the feature map X′ are reduced by a scaling coefficient, and the channel dimension is increased by a square of the scaling coefficient.

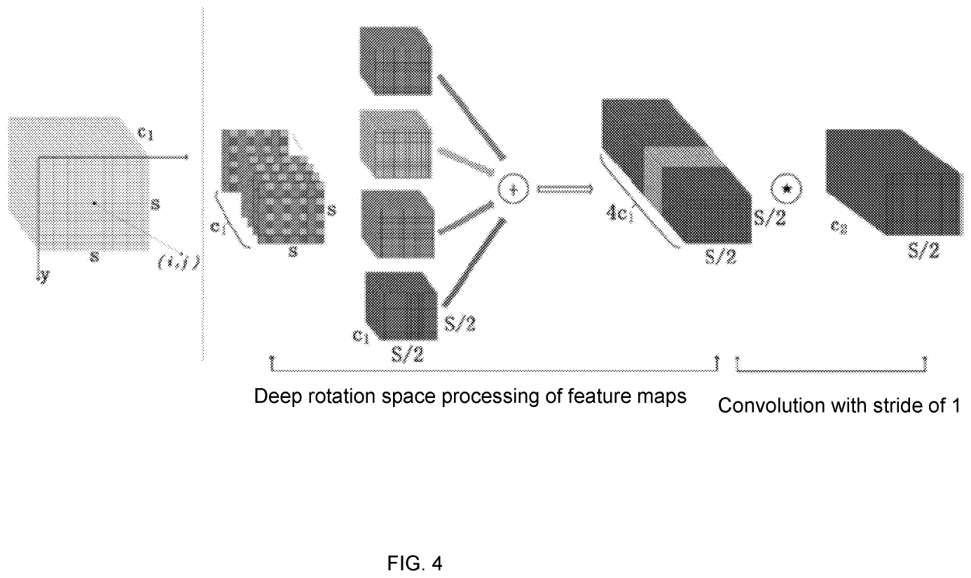

FIG. 4 is a diagram illustrating a feature map transformed by Space-to-depth when Scale=2 according to some embodiments of the present disclosure. After the feature conversion is performed in the Space-to-depth layer, a non-strided convolution layer with C₂ filters is added, where C₂<Scale²C₁. The reason for using the non-strided convolution is to preserve all discriminative information as much as possible. Otherwise, just like using a 3×3 filter with a stride of 3, the feature map may be downscaled while each pixel is sampled only once. If the stride is set to 2, asymmetric sampling may occur, where the sampling times for even rows or columns are different. Generally, a stride greater than 1 may lead to non-discriminative loss of information. Although it seemingly converts the feature map X(S, S, C₁) into

$${X}^{″} ( \frac{S}{Scale} , \frac{S}{Scale} , {Scale}^{2} {C}_{2} )$$

in form, it fails to retain the feature information of X′.

In a feature extraction layer, the network has a small receptive field and weak semantic information representation capability, but it features strong representation capability for geometric details and high resolution, making it suitable for perceiving positions and geometric details. In contrast, the deep network has a large receptive field and strong semantic information representation capability, but its representation capability for geometric information is weak, and the resolution of feature maps is low. Therefore, enhancing the interaction between high-level semantic information and low-level spatial information is the key to addressing the problem of varying target scales. To this end, the present disclosure proposes a novel global feature pyramid network (GFPN). By aggregating features at the same level and adjacent levels, GFPN achieves more effective information transmission and adopts skip connections to prevent gradient vanishing and enhance the capability of feature transmission to deeper networks. While achieving a good balance between structural size and performance, the global feature pyramid network (GFPN) exhibits excellent performance in feature fusion.

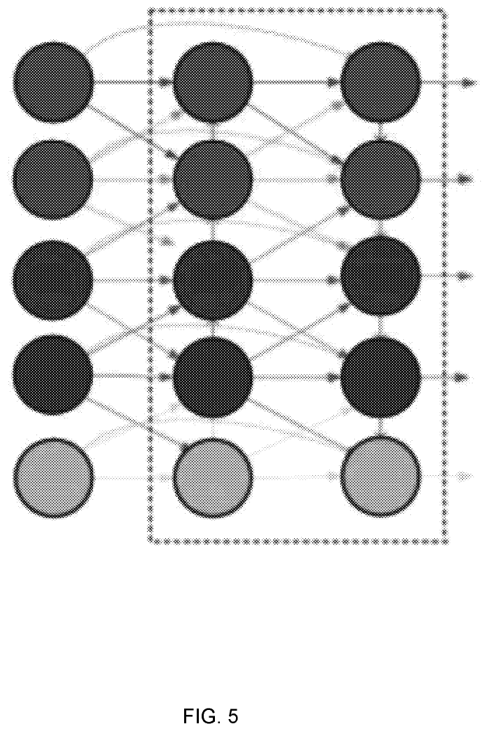

FIG. 5 is a diagram illustrating a feature fusion structure of a global feature pyramid network (GFPN) according to some embodiments of the present disclosure.

The structure of the global feature pyramid network (GFPN) has relatively high complexity compared to other feature fusion network structures. As the count of layers increases, gradient vanishing occurs. The present disclosure uses CSPStage to achieve skip connection, replaces C2f (cross-stage partial network fusion) with the global feature pyramid network (GFPN), and combines the convolution layer, so as to share information between different spatial scales and non-adjacent potential semantic layers. This enables the network to focus on high-level semantic information at the neck while avoiding loss of low-level spatial information.

In some embodiments, the GFPN in S2 utilizes CSPStage to implement the skip connection, and simultaneously replaces C2f with CSPStage and combines the convolution layer.

CSPStage (cross-stage partial stage) is a core module in the global feature pyramid network (GFPN) for feature extraction and fusion.

In some embodiments, the global feature pyramid network (GFPN) in the S2 may implement skip connection using its own CSPStage. Implementing skip connections through CSPStage can solve the information loss problem in multi-scale fusion.

C2f is an existing feature fusion module in YOLOv8.

In some embodiments, the processor may replace the C2f module of YOLOv8 with CSPStage in the global feature pyramid network (GFPN), and further adjust a count of channels and spatial information by adding standard convolutions (e.g., 1×1 or 3×3 convolutions) before and after the feature fusion is implemented in CSPStage. In some embodiments, the processor may replace C2f with CSPStage in the neck part of YOLOv8. The design of replacing C2f and combining the convolution layer reduces the computational cost of the object detection model while ensuring accuracy.

During training, the RepConv module uses convolution layers having a plurality of branches. A re-parameterization convolution (RepConv) in the CSPStage module allows the merging of a plurality of computational modules during the inference phase, thereby improving the efficiency and performance of the object detection model. During the inference process, parameters of these branches are re-parameterized into a main branch, thereby reducing the computational burden and memory requirements. Therefore, using CSPStage to realize skip connection can gradually transmit shallow feature information to the deep layer, minimize the loss of feature information, and enhance the information exchange between shallow and deep layers, so as to adapt to different scales of object detection.

In scenarios with dense small objects, an original detection head of YOLOv8 cannot meet the requirements for efficient and accurate detection tasks. Therefore, the present disclosure designs a CLLA detection head by combining a cross-level local attention (CLLA) mechanism and a distribution focal loss (DFL) to improve the recognition and localization capabilities for objects in an image.

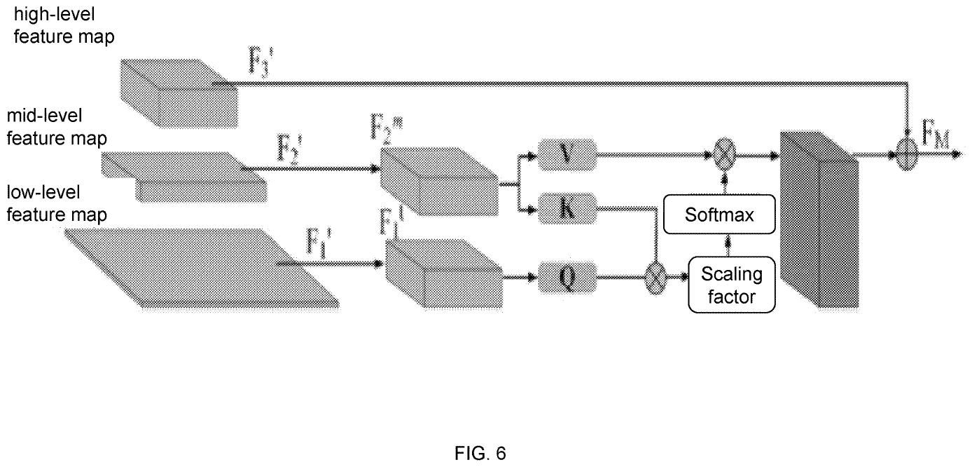

An objective of the CLLA detection head is to model the context correlation of cross-level features and aggregate multi-level features. FIG. 6 is a diagram illustrating a structure of a CLLA cross-layer local attention mechanism layer according to some embodiments of the present disclosure. As shown in FIG. 6, features at different levels usually have different recognition information. To capture more fine-grained context information between different feature maps and improve the detection accuracy and robustness of the object detection model, the present disclosure proposes embedding the CLLA detection head into the network head of YOLOv8.

In some embodiments, the CLLA detection head in S3 includes a CLLA cross-layer local attention mechanism layer and a DFL loss function layer. The CLLA cross-layer local attention mechanism layer and the DFL loss function layer are connected via the convolution layer.

The CLLA cross-layer local attention mechanism layer is a module that calculates attention weights within a limited spatial range, which is configured to dynamically adjust the importance of different regions in the feature map.

The DFL loss function layer is a module configured to optimize bounding box regression in the object detection model. The DFL loss function layer is configured to convert continuous coordinate prediction into a discrete probability distribution and improve localization accuracy by optimizing the distribution shape.

The convolution layer is configured to extract spatial features of input data via a local receptive field and a weight-sharing mechanism.

In some embodiments, the CLLA cross-layer local attention mechanism layer performs the following operations S31-S35.

In S31, it is assumed that a low-level feature map

$${F}_{1}^{′}$$

and a mid-level feature map

$${F}_{2}^{′}$$

contain shallow information, and a high-level feature map

$${F}_{3}^{′}$$

contains deep semantic information.

The low-level feature map refers to a feature map generated by a shallow convolution layer (e.g., the 1st-3rd layer convolution layers, etc.).

The mid-level feature map refers to a feature map generated by a middle convolution layer (e.g., the 4th-6th layer convolution layers, etc.).

The high-level feature map refers to a feature map generated by a deep convolution layer (e.g., a convolution layer near an output layer, etc.).

The shallow information may include texture, edge, color, etc. The deep semantic information refers to information capable of representing global, abstract, and high-level semantic concepts of the input data. For example, the deep semantic information may include object category, scene type, functional attribute, etc.

In S32, a spatial size of the low-level feature map

$${F}_{1}^{′}$$

and a spatial size of the mid-level feature map

$${F}_{2}^{′}$$

are respectively reduced by using average pooling and 1×1 convolution, and a count of channels is unified, to obtain a new low-level feature map

$${F}_{1}^{l}$$

and a new mid-level feature map

$${F}_{2}^{m} ,$$

such that the spatial size of the new low-level feature map

$${F}_{1}^{l}$$

and the spatial size of the new mid-level feature map

$${F}_{2}^{m}$$

are the same as the spatial size of the high-level feature map

$${F}_{3}^{′} .$$

A value of the unified count of channels may be preset by a person skilled in the art based on experience.

The average pooling refers to a down-sampling operation used in a convolutional neural network.

The spatial size refers to a height dimension and a width dimension of the low-level feature map or the high-level feature map.

The count of channels refers to a count of channels for parallel data transmission.

The new low-level feature map refers to a low-level feature map processed via average pooling and convolution. The new mid-level feature map refers to a mid-level feature map processed via average pooling and convolution.

In S33, learnable parameters are used to project the new low-level feature map

$${F}_{1}^{1}$$

into a space of Q, and project the new mid-level feature map

$${F}_{2}^{m}$$

into spaces of K and V, respectively, with formulas as follows:

$$\begin{matrix}Q = {F}_{1}^{l} {W}^{Q} ; \\ K = {F}_{2}^{m} {W}^{K} ; \\ V = {F}_{2}^{m} {W}^{V} ;\end{matrix}$$

where Q, K, and V represent a query vector, a key vector, and a value vector respectively, and W^{Q}, W^{K}, and W^{V} denote three learnable parameters used to generate the query vector, the key vector, and the value vector, respectively.

The learnable parameter may be understood as a weight matrix or a convolution kernel. An objective of the learnable parameter is to learn, via training data, how to optimally map the new low-level feature map

$${F}_{1}^{l}$$

to a target space Q.

The query vector represents a content that the CLLA cross-layer local attention mechanism layer currently needs to focus on.

The key vector represents a feature identifier of the input data of the CLLA cross-layer local attention mechanism layer.

The value vector represents the final actual output information of the CLLA cross-layer local attention mechanism layer.

In S34, a correlation weight between the Q and the K is calculated by using a dot product and a softmax function, and then a dot product is performed between the correlation weight and the V to obtain a new feature map.

The dot product is used to measure the similarity between two vectors Q and K. A larger dot product indicates a stronger correlation between the two vectors.

The softmax function is configured to convert a dot product score into a probability distribution, such that the weights of Q and K are non-negative and a sum of the weights of Q and K is 1.

The correlation weight between Q and K may represent the importance of K relative to Q. A higher correlation weight indicates that K is more relevant to Q, and the object detection model should pay more attention to this information.

The new feature map refers to a feature map obtained after processing the new low-level feature map and the new mid-level feature map.

In S35, the new feature map is added to the high-level feature map

$${F}_{3}^{′}$$

to obtain an aggregated feature map F_{M}, with a formula as follows:

$${F}_{M} = {F}_{3}^{l} + softmax ( \frac{( {F}_{1}^{l} {W}^{Q} ) {( {F}_{2}^{m} {W}^{K} )}^{T}}{\sqrt{{d}_{k}}} ) ( {F}_{2}^{m} {W}^{V} ) ;$$

where softmax(⋅) denotes an activation function, T denotes a matrix transpose, and dₖ denotes a vector dimension used for calculating an attention weight. dₖ is used to scale the dot product to prevent a large dot product result from causing a gradient of the softmax function to become unstable. k is a positive integer greater than zero, and may be preset by a person skilled in the art based on experience.

The aggregated feature map refers to a feature map obtained by fusing the new feature map and the high-level feature map.

The activation function refers to a function operating on a neuron of a neural network, and is responsible for mapping an input of the neuron to an output.

The attention weight is a dynamically assigned value used in a machine learning model to measure the impact degree of each part of the input data on an output result.

The vector dimension of the attention weight refers to a dimension size of the query vector (Q), the key vector (K), and the value vector (V) in an attention mechanism. The vector dimension of the attention weight may be preset by a person skilled in the art based on experience.

DFL enables a network to quickly focus on values near a label, making a probability density at the label as large as possible, guiding the object detection model to focus on objects that are difficult to detect, and improving the detection ability of the object detection model for small objects. In order to optimize probabilities (Pᵢ and Pᵢ₊₁) of two positions near the label P, an idea of DFL is to use a cross-entropy function to focus the network distribution near a label value.

In some embodiments, the DFL loss function layer uses the cross-entropy function to focus the network distribution near the label value, with a formula as follows:

$${DFL}_{( {S}_{i} {S}_{i + 1} )} = - ( ( {P}_{i + 1} - P ) log ( {S}_{i} ) + ( P - {P}_{i} ) log ( {S}_{i + 1} ) ) ;$$

where DFL₍ₛ_{ᵢ}_{,s}_{ᵢ₊₁}₎ denotes a distributed focus loss of a predicted value at two adjacent positions i and i+1, Sᵢ denotes an output of a network Sigmoid at the position i, Sᵢ₊₁ denotes an output of the network Sigmoid at the position i+1, Pᵢ denotes a probability of a label P at the position i, and Pᵢ₊₁ denotes a probability of the label P at the position i+1. A value of i is a positive integer greater than zero.

The cross-entropy function is a function for measuring a difference between two probability distributions.

In some embodiments of the present disclosure, in order to evaluate and verify the detection performance of the structure of the object detection model proposed in the present disclosure, two challenging underwater object detection datasets are used for experiments, which are the China Underwater Robot Professional Contest (URPC) dataset and a publicly available European underwater image dataset Brackish.

The present disclosure uses the precision (P), the recall (R), the average precision (mAP), the computational complexity (FLOPs), the count of parameters (Parameters), and frames per second (FPS) to evaluate the effectiveness of the object detection model. P reflects an accuracy of classifying positive samples, R reflects an effectiveness of identifying positive samples, mAP represents an average precision of all categories, FLOPs represents a count of floating-point operations, FLOPs can be used to represent a model complexity of the object detection model, Parameters represents a count of parameters of the object detection model, and frames per second (FPS) represents a count of static frames displayed per second in a video. The formulas are as follows:

$$\begin{matrix}P = \frac{TP}{FP} ; \\ R = \frac{TP}{TP + FN} ; \\ mAP = \frac{{\sum }_{i = 1}^{k} {AP}_{i}}{k} ; \\ AP = {\int }_{0}^{1} P ( r ) dr ;\end{matrix}$$

where TP denotes a count of positive class samples predicted as correct predictions by the object detection model, FP denotes a count of negative class samples predicted as incorrect predictions, FN denotes a count of positive class samples predicted as incorrect predictions, P(r) represents a precision-recall curve, k denotes a count of categories in a current recognition task, in an object detection task, mAP depends on a selected IoU threshold, and mAP@0.5 represents an average precision obtained by the object detection model on the object detection task when the IoU threshold is 0.5.

In order to verify the detection performance and model complexity of the object detection model proposed in the present disclosure, and to explore the impact of specific substructures of the network of the object detection model, an ablation experiment based on YOLOv8n is designed. The experimental results are shown in Table 1, wherein bold indicates the best performance.

TABLE 1
Ablation experiment results on the URPC and Brackish datasets

| | | | | | URPC contest/% | | | Brackish contest/% | | | | | |
|---|---|---|---|---|---|---|---|---|---|---|---|---|---|
| | | | | | evalua- | | average | evalua- | | average | | computa- | |
| | | | | | ting | | pre- | ting | | pre- | A count | tional | |
| | | | | | pre- | | cision | pre- | | cision | of param- | complex- | model |
| Group | RepGhost | SPD-Conv | GFPN | CLLAHead | cision | recall | @0.5 | cision | recall | @0.5 | eters/M | ity/G | size/Mb |
| 1 | | | | | 79.7 | 64.2 | 71.9 | 96.3 | 94.2 | 96.9 | 3.2 | 8.9 | 6.0 |
| 2 | ✓ | | | | 78.9 | 63.7 | 71.5 | 97.3 | 94.4 | 97.2 | 2.6 | 7.8 | 6.3 |
| 3 | | ✓ | | | 80.0 | 65.4 | 72.8 | 97.1 | 94.8 | 97.4 | 2.8 | 7.6 | 5.9 |
| 4 | | | ✓ | | 81.3 | 64.3 | 72.5 | 97.0 | 95.2 | 97.6 | 3.1 | 8.1 | 6.0 |
| 5 | | | | ✓ | 81.1 | 64.8 | 72.3 | 97.1 | 94.4 | 96.8 | 3.0 | 7.7 | 6.0 |
| 6 | ✓ | ✓ | | | 80.3 | 65.1 | 72.6 | 96.8 | 94.9 | 97.1 | 2.9 | 7.3 | 5.8 |
| 7 | ✓ | ✓ | ✓ | | 81.4 | 65.4 | 73.8 | 97.3 | 95.1 | 97.7 | 2.8 | 7.8 | 5.8 |
| 8 | ✓ | ✓ | ✓ | ✓ | 82.1 | 68.7 | 74.1 | 97.4 | 95.4 | 97.5 | 2.7 | 7.2 | 5.7 |

The first set of experiments is mainly to evaluate the detection capability of an original object detection model (YOLOv8n). Then, the model is improved individually or collectively, including optimizing using the RepGhost re-parameterization module, the SPD convolution module (SPD-Conv), the global feature pyramid network (GFPN), and the CLLA detection head (CLLA Head), to evaluate the effectiveness of applying the four improvement techniques in the two datasets. The original model achieves precision rates of 79.7 and 96.3 on the URPC and Brackish datasets, respectively. After evaluating each improvement measure separately, it is found that the accuracy metric on the URPC dataset is slightly reduced by introducing the RepGhost re-parameterization module, but it can effectively alleviate the problem of excessive model parameters and high computational complexity. Moreover, in the subsequent combination experiments, the RepGhost re-parameterization module has a positive impact on the performance of the underwater object detection task. On the Brackish dataset, however, the RepGhost re-parameterization module brings positive effects on both model accuracy and complexity. In addition, it is also found that the global feature pyramid network (GFPN) provides relatively significant performance improvements on both datasets, which further indicates that the GFPN feature fusion method is feasible and effective in underwater small object detection.

The LFN-YOLO network proposed in the present disclosure achieves accuracy rates of 82.1% and 97.4% on the URPC and Brackish datasets, respectively, which are 2.4% and 1.1% higher than the original model, while the count of parameters and GFLOPs are reduced by 15.6% and 19.1%, respectively. Additionally, the recall rate and mAP@0.5 of the network on the URPC dataset are increased by 1.5% and 2.2%, respectively, and by 1.3% and 0.6% respectively, on the Brackish dataset. These results demonstrate the adaptability and robustness of the LFN-YOLO model in different underwater environments.

In order to further illustrate that the LFN-YOLO model can better balance model complexity and accuracy, a comparative experiment is conducted with eight other mainstream one-stage detection models. All experiments are performed under the same settings, using the accuracy, the recall, mAP@0.5, the count of parameters, computational complexity, and model size to evaluate the performance of the model. Specific results are shown in Table 2. All algorithms in the experiment meet real-time monitoring requirements. LFN-YOLO exhibits higher detection accuracy while having a more lightweight model complexity.

TABLE 2
Comparative experiment of LFN-YOLO on URPC and Brackish datasets

| | URPC contes | | | | Brackish contest | | | | A count | | |
|---|---|---|---|---|---|---|---|---|---|---|---|
| | evaluating | | mAP@ | | evaluating | | mAP@ | | of param- | computational | model |
| model | precision/% | Recall/% | 0.5/% | FP | precision/% | Recall/% | 0.5/% | FPS | eters/M | complexity/G | size/Mb |
| YOLOv5n | 77.9 | 64.3 | 71.8 | 44 | 96.1 | 94.1 | 96.9 | 51 | 2.7 | 7.8 | 5.0 |
| YOLOv6-N | 78.0 | 62.1 | 70.7 | 57 | 96.6 | 92.3 | 96.4 | 61 | 4.5 | 11.9 | 8.3 |
| YOLOv7-tiny | 83.6 | 64.9 | 73.2 | 48 | 95.7 | 93.1 | 96.5 | 58 | 6.2 | 13.2 | 12.0 |
| YOLOv8n | 79.7 | 64.2 | 71.9 | 52 | 96.3 | 94.2 | 96.9 | 59 | 3.2 | 8.9 | 6.0 |
| YOLOv9t | 80.2 | 64.6 | 73.1 | 37 | 97.3 | 95.0 | 97.3 | 39 | 2.0 | 7.9 | 8.3 |
| YOLOv10n | 75.8 | 63.9 | 70.8 | 42 | 96.2 | 94.3 | 97.0 | 42 | 2.7 | 8.4 | 3.5 |
| SSD | 84.4 | 68.4 | 75.4 | 51 | 92.5 | 92.8 | 95.8 | 57 | 26.3 | 116.2 | 92.1 |
| Mobilevit_v3-YOLO | 76.7 | 58.2 | 66.0 | 44 | 94.2 | 94.2 | 96.9 | 48 | 2.3 | 5.4 | 4.8 |
| LFN-YOLO | 82.1 | 65.7 | 74.1 | 58 | 97.4 | 95.4 | 97.5 | 63 | 2.7 | 7.2 | 5.7 |

According to the experimental results in Table 2, LFN-YOLO achieves a mAP@0.5 of 74.1% on the URPC dataset, which is 2.3%, 3.4%, 2.2%, 3.3%, and 8.1% higher than YOLOv5n, YOLOv6-N, YOLOv8n, YOLOv10n, and Mobilevit_v3-YOLO, respectively. Although LFN-YOLO is not as lightweight as Mobilevit_v3-YOLO in terms of the model size, the count of parameters, and the GFLOPs (giga floating-point operations) metrics, its performance on accuracy metrics is significantly higher than that of Mobilevit_v3-YOLO. An SSD model with VGG-16 as a backbone network has the best performance on the URPC dataset, but does not perform well on the Brackish dataset, and does not have the generalization and robustness that the underwater object recognition model should have. Furthermore, the SSD algorithm has a large count of parameters among many one-stage algorithms, which is not suitable for object recognition tasks of underwater unmanned platforms. It is worth noting that among the one-stage algorithms in the comparative experiment, only RetinaNet requires relatively high hardware performance to meet the real-time requirements of underwater detection tasks, and the relatively low FPS makes it unsuitable for real-time underwater object detection. In summary, LFN-YOLO can not only correctly identify objects in underwater images but also obtain a high confidence level. It has the lightest structure among the compared networks.

The general technical staff in this field realizes that the embodiments described here are intended to help readers understand the principles of the present disclosure and should understand that the scope of protection of the present disclosure is not limited to such specific statements and embodiments. General technicians in this field can make various other specific modifications and combinations that are not divorced from the essence of the present disclosure based on these technical revelations disclosed in the present specification, and these deformations and combinations are still within the protection of the invention.

Having thus described the basic concepts, it may be rather apparent to those skilled in the art after reading this detailed disclosure that the foregoing detailed disclosure is intended to be presented as an illustrative example and is not limiting. Various alterations, improvements, and modifications may occur and are intended for those skilled in the art, though not expressly stated herein. These alterations, improvements, and modifications are intended to be suggested by this disclosure, and are within the spirit and scope of the exemplary embodiments of the present disclosure.

Moreover, certain terminology has been configured to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various portions of this disclosure are not necessarily all referring to the same embodiment. Furthermore, the particular features, structures, or characteristics may be combined as suitable in one or more embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure, aiding in the understanding of one or more of the various inventive embodiments. This way of disclosure, however, is not to be interpreted as reflecting an intention that the claimed subject matter requires more features than are expressly recited in each claim. Rather, inventive embodiments lie in fewer than all features of a single foregoing disclosed embodiment.

In some embodiments, the numbers expressing quantities or properties configured to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameter set forth in the written description and attached claims is an approximation that may vary depending upon the desired properties sought to be obtained by a particular embodiment. In some embodiments, the numerical parameter should be construed in light of the number of reported significant digits and by applying ordinary rounding techniques. Notwithstanding that the numerical ranges and parameter setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A lightweight underwater object detection method, comprising:
S1: using YOLOv8 as a baseline model, implementing feature reuse in a network backbone of the YOLOv8 using a lightweight RepGhost re-parameterization module, and replacing a convolution layer of the network backbone with an SPD convolution module;
S2: replacing a network neck of the YOLOv8 with a global feature pyramid network (GFPN) for feature fusion;
S3: replacing a network head of the YOLOv8 with a CLLA detection head to improve recognition and positioning of an object, thereby obtaining a lightweight underwater object detection model;
S4: performing performance evaluation on the lightweight underwater object detection model, and applying the lightweight underwater object detection model to a real-world scenario to realize underwater object detection, wherein
the CLLA detection head in S3 comprises a CLLA cross-layer local attention mechanism layer and a DFL loss function layer, and the CLLA cross-layer local attention mechanism layer and the DFL loss function layer are connected via the convolution layer;
the CLLA cross-layer local attention mechanism layer performs operations including:
S31: assuming that a low-level feature map
$${F}_{1}^{′}$$
and a mid-level feature map
$${F}_{2}^{′}$$
contain shallow information, and a high-level feature map
$${F}_{3}^{′}$$
contains deep semantic information;
S32: respectively reducing a spatial size of the low-level feature map
$${F}_{1}^{′}$$
and a spatial size of the mid-level feature map
$${F}_{2}^{′}$$
by using average pooling and 1×1 convolution, and unifying a count of channels, to obtain a new low-level feature map
$${F}_{1}^{l}$$
and a new mid-level feature map
$${F}_{2}^{m} ,$$
such that the spatial size of the new low-level feature map
$${F}_{1}^{l}$$
and the spatial size of the new mid-level feature map
$${F}_{2}^{m}$$
are the same as the spatial size high-level feature map
$${F}_{3}^{′} ;$$
S33: using learnable parameters to project the new low-level feature map
$${F}_{1}^{1}$$
into a space of Q, and to project the new mid-level feature map
$${F}_{2}^{m}$$
into spaces of K and V respectively, with formulas as follows:
$$\begin{matrix}Q = {F}_{1}^{l} {W}^{Q} ; \\ K = {F}_{2}^{m} {W}^{K} ; \\ V = {F}_{2}^{m} {W}^{V} ;\end{matrix}$$
where Q, K, and V represent a query vector, a key vector, and a value vector respectively, and W^{Q}, W^{K}, and W^{V} denote three learnable parameters used to generate the query vector, the key vector, and the value vector respectively;
S34: calculating a correlation weight between the Q and the K by using a dot product and a softmax function, and then performing a dot product between the correlation weight and the V to obtain a new feature map;
S35: adding the new feature map to the high-level feature map
$${F}_{3}^{′}$$
to obtain an aggregated feature map F_{M}, with a formula as follows:
$${F}_{M} = {F}_{3}^{′} + softmax ( \frac{( {F}_{1}^{l} {W}^{Q} ) {( {F}_{2}^{m} {W}^{K} )}^{T}}{\sqrt{{d}_{k}}} ) ( {F}_{2}^{m} {W}^{V} ) ;$$
where softmax(⋅) denotes an activation function, T denotes a matrix transpose, and dₖ denotes a vector dimension used for calculating an attention weight;
the DFL loss function layer uses a cross-entropy function to focus a network distribution near a label value, with a formula as follows:
$${DFL}_{( {S}_{i} , {S}_{i + 1} )} = - ( ( {P}_{i + 1} - P ) log ( {S}_{i} ) + ( P - {P}_{i} ) log ( {S}_{i + 1} ) ) ;$$
where DFL₍ₛ_{ᵢ}_{,s}_{ᵢ₊₁}₎ denotes a distributed focus loss of a predicted value at two adjacent positions i and i+1, Sᵢ denotes an output of a network Sigmoid at the position i, Sᵢ₊₁ denotes an output of the network Sigmoid at the position i+1, Pᵢ denotes a probability of a label P at the position i, and Pᵢ₊₁ denotes a probability of the label P at the position i+1.

2. The lightweight underwater object detection method according to claim 1, wherein the RepGhost re-parameterization module in S1 utilizes re-parameterization technology to sequentially add a batch normalization layer, an Add connection layer, and an activation layer after a deformable convolution layer, and add a batch normalization branch between the deformable convolution layer and the Add connection layer.

3. The lightweight underwater object detection method according to claim 1, wherein the SPD convolution module in S1 performs operations including:
S11: downsampling an original feature map X(S×S×C₁) having a size of S×S×C₁ using a scaling factor to obtain feature sub-maps, wherein S denotes a spatial dimension of the original feature map, and C₁ denotes a count of channels of the original feature map;
S12: connecting the feature sub-maps along a channel dimension to obtain a feature map X′(S Scale, S Scale, Scale²C₁), wherein Scale denotes a scaling coefficient; and
S13: converting the feature map X′(S Scale, S Scale, Scale²C₁) into
$${X}^{″} ( \frac{s}{Scale} , \frac{s}{Scale} , {Scale}^{2} {C}_{2} )$$
by adding a convolution layer with C₂ filters.

4. The lightweight underwater object detection method according to claim 3, wherein a formula for obtaining the feature sub-maps in S11 is:
$$\begin{matrix}{f}_{x , y} = X [ x : S : Scale , y : S : Scale ] , \\ x = 0 , 1 , … , Scale - 1 , y = 0 , 1 , … , Scale - 1 ;\end{matrix}$$
where f_{x,y} denotes the feature sub-map, X[⋅] represents an input feature map or tensor, and x and y denote coordinate subscript indices.

5. The lightweight underwater object detection method according to claim 1, wherein the GFPN in S2 utilizes CSPStage to implement a skip connection, and simultaneously replaces C2f with the CSPStage and combines the convolution layer.
